(19) United States
(12) Patent Application Publication
(10) Pub. No.: US 2023/0100857 A1
(43) Pub. Date: Mar. 30, 2023

(54) VEHICLE REMOTE CONTROL SYSTEM

(71) Applicant: Kipling Martin, Aurora, CO (US)

(72) Inventor: Kipling Martin, Aurora, CO (US)

(21) Appl. No.: 17/485,385

(22) Filed: Sep. 25, 2021

(51) Int. Cl. G05D 1/00; B60W 50/14; G02B 27/01; G06T 19/00

(52) U.S. Cl. CPC G05D 1/0044; G05D 1/0038; G05D 1/0016; B60W 50/14; G02B 27/017; G06T 19/006; G05D 2201/0213; B60W 2050/146; G02B 2027/0178; G06T 2219/2012

(57) ABSTRACT

A vehicle remote control system having a program running thereon, the vehicle remote control system including a storage device to store data regarding at least one vehicle, a remote control assembly connected to the storage device and the at least one vehicle to control the at least one vehicle corresponding to at least one component of the remote control assembly, and a display assembly to be worn by a user and connected to the remote control assembly to display a virtual reality image based on an exterior environment and an interior environment of the at least one vehicle thereon.

### BACKGROUND

### 1. Field

The present general inventive concept relates generally to vehicles, and particularly, to a vehicle remote control system.

### 2. Description of the Related Art

Autonomous vehicles, also known as self-driving vehicles, are vehicles that have little to no human intervention. Generally, autonomous vehicles use a collaboration of different mechanical and/or electronic control systems. One of the primary components include a variety of sensors that monitors an environment surrounding the autonomous vehicle at any given time. As such, the sensors allow the vehicle to maintain awareness of the environment.

Collectively, the sensors enable the autonomous vehicle to keep track of motion, changes in the environment, and/or operation of components of the autonomous vehicle. Moreover, the components of the autonomous vehicle must be adjusted in response to potential issues detected by the sensors.

Currently, most autonomous vehicles still require human intervention. More specifically, the autonomous cars and/or autonomous trucks have difficulty navigating through inner city environments where landscape changes tend to happen more frequently than on a highway and/or an expressway. As such, autonomous vehicles lack the ability to drive through the inner city.

In cases, where the autonomous vehicle is used for a business and/or delivery of goods, the necessity of having at least one person to ride within the autonomous vehicle increases costs. Also, the at least one person would have to be present for the ride. However, even if the at least one person only assumed control of the autonomous vehicle at the destination city, completion of the drive relies on the at least one person being physically present.

Therefore, there is a need for a vehicle remote control system that allows the at least one person to remotely drive the autonomous vehicle.

### SUMMARY

The present general inventive concept provides a vehicle remote control system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a vehicle remote control system having a program running thereon, the vehicle remote control system including a storage device to store data regarding at least one vehicle, a remote control assembly connected to the storage device and the at least one vehicle to control the at least one vehicle corresponding to at least one component of the remote control assembly, and a display assembly to be worn by a user and connected to the remote control assembly to display a virtual reality image based on an exterior environment and an interior environment of the at least one vehicle thereon.

The remote control assembly may include a body, a processing unit disposed within at least a portion of the body to determine a vehicle control command based on the program, a remote steering wheel rotatably disposed on at least a portion of the body to at least partially rotate a steering wheel of the at least one vehicle in response to rotation of the remote steering wheel, a remote accelerator pedal movably disposed on at least a portion of the body to at least partially depress an accelerator pedal of the at least one vehicle in response to depressing the remote accelerator pedal, a remote brake pedal movably disposed on at least a portion of the body to at least partially depress a brake pedal of the at least one vehicle in response to depressing the remote brake pedal, and a remote gear shifter movably disposed on at least a portion of the body to move a gear shifter of the at least one vehicle in response to moving the remote gear shifter.

The remote control assembly may further include a remote clutch pedal movably disposed on at least a portion of the body to at least partially depress a clutch pedal of the at least one vehicle in response to depressing the remote clutch pedal.

The display assembly may include an eyewear body, and a display unit disposed on at least a portion of the eyewear body to generate the virtual reality image on the display unit based on the exterior environment and the interior environment of the at least one vehicle.

The display unit may dynamically generate the virtual reality image.

The display unit may generate an overlay of information related to operation of the at least one vehicle over the virtual reality image.

The display assembly may change at least one of at least one surrounding vehicle, an object, and a pedestrian to a color in response to identifying a presence of at least one of the at least one surrounding vehicle, the object, and the pedestrian.

The display assembly may display a warning to identify potential problems surrounding the at least one vehicle, such that the potential problems are at least one of potential collisions, pedestrians, traffic jams along a current route of travel, weather, and slippery roads.

The vehicle remote control system may further include a plurality of cameras disposed on at least a portion of the at least one vehicle to record at least one of an image and a video of the exterior environment and the interior environment of the at least one vehicle.

The vehicle remote control system may further include a vehicle driving unit disposed on at least a portion of the at least one vehicle to operate at least one component of the at least one vehicle in response to activating the at least one component of the remote control assembly, such that the at least one component of the remote control assembly corresponds to the at least one component of the at least one vehicle.

The foregoing and/or other features and utilities of the present general inventive concept may also be achieved by providing a vehicle remote control system having a program running thereon, the vehicle remote control system including a storage device to store data regarding at least one vehicle, a remote control assembly connected to the storage device and the at least one vehicle to control the at least one vehicle corresponding to at least one component of the remote control assembly, and a plurality of monitors removably connected to at least a portion of the remote control assembly to display an exterior environment and an interior environment of the at least one vehicle thereon.

The remote control assembly may include a body, a processing unit disposed within at least a portion of the body to determine a vehicle control command based on the program, a remote steering wheel rotatably disposed on at least a portion of the body to at least partially rotate a steering wheel of the at least one vehicle in response to rotation of the remote steering wheel, a remote accelerator pedal movably disposed on at least a portion of the body to at least partially depress an accelerator pedal of the at least one vehicle in response to depressing the remote accelerator pedal, a remote brake pedal movably disposed on at least a portion of the body to at least partially depress a brake pedal of the at least one vehicle in response to depressing the remote brake pedal, and a remote gear shifter movably disposed on at least a portion of the body to move a gear shifter of the at least one vehicle in response to moving the remote gear shifter.

The remote control assembly may further include a remote clutch pedal movably disposed on at least a portion of the body to at least partially depress a clutch pedal of the at least one vehicle in response to depressing the remote clutch pedal.

Each of the plurality of monitors may include a monitor body, and a display unit disposed on at least a portion of the monitor body to generate a rendered image on the display unit based on the exterior environment and the interior environment of the at least one vehicle.

The display unit may dynamically generate the rendered image.

The display unit may generate an overlay of information related to operation of the at least one vehicle over the rendered image.

Each of the plurality of monitors may change at least one of at least one surrounding vehicle, an object, and a pedestrian to a color in response to identifying a presence of at least one of the at least one surrounding vehicle, the object, and the pedestrian.

Each of the plurality of monitors may display a warning to identify potential problems surrounding the at least one vehicle, such that the potential problems may be at least one of potential collisions, pedestrians, traffic jams along a current route of travel, weather, and slippery roads.

The vehicle remote control system may further include a plurality of cameras disposed on at least a portion of the at least one vehicle to record at least one of an image and a video of the exterior environment and the interior environment of the at least one vehicle.

The vehicle remote control system may further include a vehicle driving unit disposed on at least a portion of the at least one vehicle to operate at least one component of the at least one vehicle in response to activating the at least one component of the remote control assembly, such that the at least one component of the remote control assembly corresponds to the at least one component of the at least one vehicle.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a vehicle remote control system, according to an exemplary embodiment of the present general inventive concept;

FIG. 2A illustrates a perspective view of a plurality of cameras as disposed on an exterior of at least one vehicle, according to an exemplary embodiment of the present general inventive concept;

FIG. 2B illustrates a perspective view of a vehicle driving unit as disposed on an interior of the at least one vehicle, according to an exemplary embodiment of the present general inventive concept;

FIG. 3 illustrates a perspective view of a remote control assembly and a display assembly, according to an exemplary embodiment of the present general inventive concept; and

FIG. 4 illustrates a perspective view of the remote control assembly and a display assembly, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Vehicle Remote Control System 100
Storage Device 110
Cameras 120
Exterior Cameras 121
Interior Cameras 122
Vehicle Driving Unit 130
Processing Unit 131
Communication Unit 132
Storage Unit 133
Input Unit 134
Control Motor 135
Remote Control Assembly 140
Body 140a
Processing Unit 141
Communication Unit 142
Storage Unit 143
Remote Steering Wheel 144
Remote Accelerator Pedal 145
Remote Brake Pedal 146
Remote Clutch Pedal 147
Remote Gear Shifter 148
Driver Seat 149
Display Assembly 150
Eyewear Body 151
Display Unit 152
Network 160
Display Assembly 250
Monitor Body 251
Display Unit 252

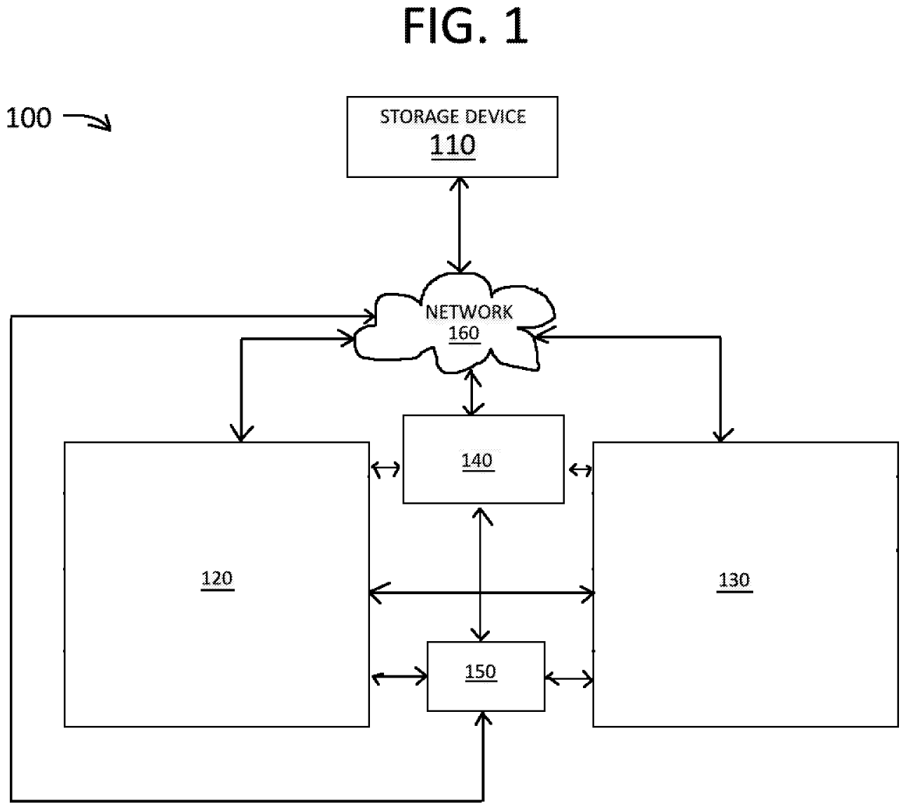

FIG. 1 illustrates a vehicle remote control system 100, according to an exemplary embodiment of the present general inventive concept.

The vehicle remote control system 100 may include a storage device 110, a plurality of cameras 120, a vehicle driving unit 130, a remote control assembly 140, a display assembly 150, and a network 160, but is not limited thereto.

The storage device 110 may include a server, a computing device with a storage unit, and a cloud-based storage space, but is not limited thereto. The storage device 110 may store and/or execute a software program and/or application running thereon to control at least one vehicle 10. More specifically, the storage device 110 may have a program running thereon to control and/or receive camera data from the plurality of cameras 120. Moreover, the storage device 110 may store operation data for the vehicle driving unit 130 disposed within the at least one vehicle 10, the remote control assembly 140, and/or the display assembly 150. As such, the storage device 110 may store data regarding driving and/or movement of the at least one vehicle 10 using the remote control assembly 140.

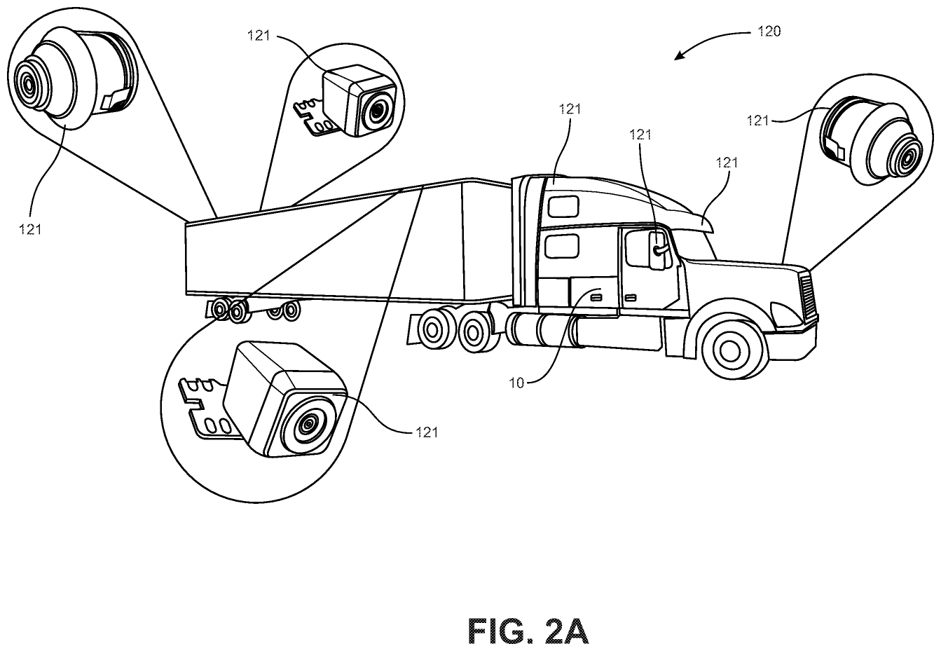

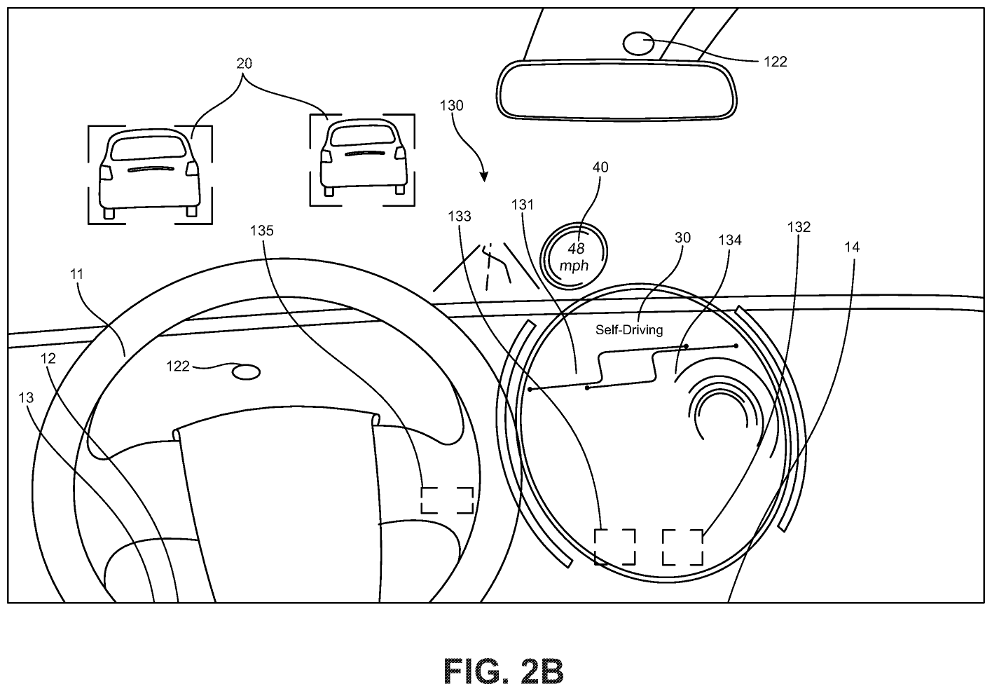

FIG. 2A illustrates a perspective view of a plurality of cameras 120 as disposed on an exterior of at least one vehicle 10, according to an exemplary embodiment of the present general inventive concept.

The plurality of cameras 120 may include a plurality of exterior cameras 121 and a plurality of interior cameras 122, but is not limited thereto.

Each of the plurality of cameras 120 may be any type of camera known to one of ordinary skill in the art, including, but not limited to, an action camera, an animation camera, an autofocus camera, a box camera, a camcorder, a camera phone, a compact camera, a dashboard camera (i.e., a Dashcam), a digital camera, a field camera, a FIREWIRE camera, a helmet camera, a high-speed camera, an instant camera, a keychain camera, a live-preview digital camera, a movie camera, an omnidirectional camera, a pinhole camera, a pocket camera, a pocket video camera, a rangefinder camera, a reflex camera, a remote camera, a stereo camera, a still camera, a still video camera, a subminiature camera, a system camera, a thermal imaging camera, a thermographic camera, a traffic camera, a traffic enforcement camera, a twin-lens reflex camera, a video camera, a view camera, a webcam, a WRIGHT camera, a ZENITH camera, and a zoom-lens reflex camera.

It is important to note that each of the plurality of cameras 120 may alternatively be a sensor, radar, lidar, sonar, global positioning system (GPS), odometry, inertial measurement units (IMU), and/or any combination thereof. In other words, the plurality of cameras 120 may be a plurality of radar devices 120 to emit radio waves to detect distance, angle, speed, and/or direction of an object. Also, the plurality of cameras 120 may be a plurality of IMUs 120 that measures an object's force, angular rate, and/or orientation using accelerometers, gyroscopes, and/or magnetometers.

The plurality of exterior cameras 121 may be removably connected to at least a portion of the exterior of the at least one vehicle 10. The plurality of exterior cameras 121 may record at least one image and/or at least video thereon. More specifically, the plurality of exterior cameras 121 may record a surrounding exterior environment of the at least one vehicle 10, such as a road, another vehicle, a pedestrian, etc. Also, referring to FIG. 2A, the plurality of exterior cameras 121 may be disposed at different portions of the at least one vehicle 10 to provide different views, angles, and/or orientations of the at least one vehicle 10 and/or the surrounding environment of the at least one vehicle 10.

FIG. 2B illustrates a perspective view of a vehicle driving unit 130 as disposed on an interior of the at least one vehicle 10, according to an exemplary embodiment of the present general inventive concept.

The plurality of interior cameras 122 may be removably connected within at least a portion of the interior of the at least one vehicle 10. The plurality of interior cameras 122 may record at least one image and/or at least video thereon. More specifically, the plurality of interior cameras 121 may record an interior environment of the at least one vehicle 10, such as a driver's seat, a passenger seat, each front seat, each rear seat, etc. Also, referring to FIG. 2B, the plurality of interior cameras 122 may be disposed at different portions of the at least one vehicle 10 to provide different views, angles, and/or orientations of the at least one vehicle 10 and/or the interior environment of the at least one vehicle 10.

The vehicle driving unit 130 may include a processing unit 131, a communication unit 132, a storage unit 133, an input unit 134, and a control motor 135, but is not limited thereto.

The vehicle driving unit 130 may be disposed within at least a portion of the interior of the at least one vehicle 10 and/or connected to the plurality of cameras 120.

The processing unit 131 (or central processing unit, CPU) may include electronic circuitry to carry out instructions of a computer program by performing basic arithmetic, logical, control and input/output (I/O) operations specified by the instructions. The processing unit 131 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 131 may also include a microprocessor and a microcontroller.

The communication unit 132 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit 133 may include a random access memory (RAM), a read-only memory (ROM), a hard disk, a flash drive, a database connected to the Internet, cloud-based storage, Internet-based storage, or any other type of storage unit.

The vehicle driving unit 130 may access the Internet via the communication unit 132 to access a website, and/or allow a mobile application and/or the software application to be executed using the processing unit 131. For ease of description, the mobile and/or the software application will be hereinafter referred to as an app. The app may be downloaded from the Internet, such as the storage device 110, to be stored on the storage unit 133. In other words, the program stored on the storage device 110 may be the same as the app stored on the storage unit 133 of the vehicle driving unit 130.

The processing unit 131 executing the app may automatically drive using artificial intelligence (A.I.) of the at least one vehicle 10. In other words, the processing unit 131 executing the app may autonomously drive the at least one vehicle 10 based on configuring the processing unit 131 to use an autonomous driving mode and/or a self-driving mode. More specifically, the processing unit 131 executing the app may monitor the surrounding environment of the exterior of the at least one vehicle 10 using the plurality of exterior cameras 121. Moreover, the processing unit 131 executing the app may follow local traffic laws and/or conventional driving behaviors, such as stopping at red lights, stop signs, moving on green light, slowing in response to detecting another at least one vehicle within a predetermined range of the at least one vehicle 10 (e.g., five feet, ten feet, twenty feet) based on a speed of the at least one vehicle 10 and/or the another at least one vehicle, changing lanes based on the surrounding environment, staying within traffic lanes, yielding to pedestrians and/or animals, etc. In other words, the processing unit 131 may operate the at least one vehicle 10 in response to the camera data received from the plurality of exterior cameras 121 and/or the plurality of interior cameras 122.

Also, the processing unit 131 executing the app may monitor the interior environment of the at least one vehicle 10 using the plurality of interior cameras 122. The processing unit 131 executing the app may adjust a temperature level based on observed behavior of occupants, such as at least one passenger and/or an animal, such as sweat and/or voice patterns. For example, the processing unit 131 executing the app may decrease the temperature level in response to the plurality of interior cameras 122 detecting sweat on the occupants. Alternatively, the processing unit 131 executing the app may increase the temperature level in response to the plurality of interior cameras 122 detecting shivering by the occupants.

Furthermore, the processing unit 131 executing the app may store a record of the camera data from the plurality of exterior cameras 121, the camera data from the plurality of interior cameras 122, and/or vehicle data (e.g., driving, events, accident) on the storage unit 133.

The input unit 134 may include a keyboard, a touchpad, a mouse, a trackball, a stylus, a voice recognition unit, a visual data reader, a camera, a wireless device reader, and a holographic input unit. Also, the input unit 134 may further include a plasma screen, an LCD screen, a light emitting diode (LED) screen, an organic LED (OLED) screen, a computer monitor, a hologram output unit, a sound outputting unit, or any other type of device that visually or aurally displays data. As such, the input unit 134 may be a touch-screen.

The input unit 134 may be disposed on at least a portion of the at least one vehicle 10. The input unit 134 may receive at least one command therein, such as activating the autonomous driving mode and/or controlling other functions of the at least one vehicle 10. For example, the input unit 134 may control the temperature level, radio control, headlight functions, windshield wipers, door lock and/or unlock, window control, and/or any other vehicle operations.

The control motor 135 may be disposed within at least a portion of the at least one vehicle 10. Additionally, the control motor 135 may be a singular motor and/or a plurality of control motors 135 based on complexity and/or necessary components to operate the at least one vehicle 10. The control motor 135 may be connected to a steering wheel 11, an accelerator/clutch pedal 12 (i.e., may be two separate pedals depending on a type of the at least one vehicle 10), a brake pedal 13, and/or a gear shifter 14. Accordingly, the steering wheel 11 may rotate in a first rotational direction (i.e., clockwise) or a second rotational direction (i.e., counterclockwise) in response to rotation of the control motor 135. The accelerator/clutch pedal 12 may depress in response to rotation of the control motor 135. The brake pedal 13 may depress in response to rotation of the control motor 135. The gear shifter 14 may move in response to rotation of the control motor 135.

The control motor 135 may move (i.e., rotate) in response to a command from the processing unit 131. In other words, the processing unit 131 executing the app may move the control motor 135 based on required movement of the at least one vehicle 10 during the autonomous driving mode. For example, the control motor 135 may steer the at least one vehicle 10 in response to rotating the steering wheel 11 clockwise in the first rotational direction to allow the at least one vehicle 10 to turn right. Subsequently, the control motor 135 may accelerate the at least one vehicle 10 in response to depressing the accelerator pedal 12, and/or decelerate and/or stop the at least one vehicle 10 in response to depressing the brake pedal 13.

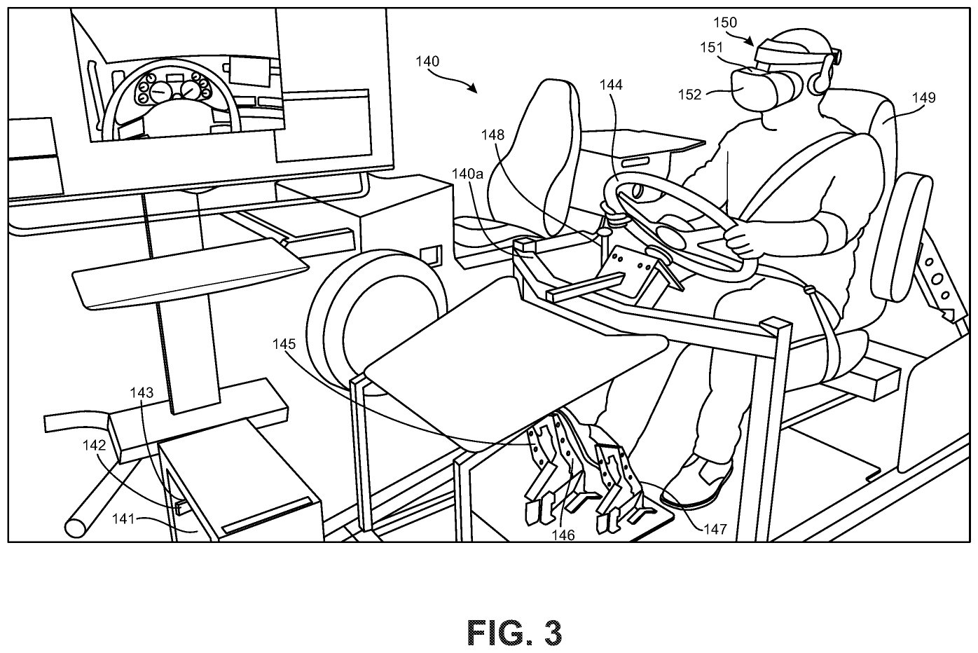

FIG. 3 illustrates a perspective view of a remote control assembly 140 and a display assembly 150, according to an exemplary embodiment of the present general inventive concept.

The remote control assembly 140 may include a body 140a, a processing unit 141, a communication unit 142, a storage unit 143, a remote steering wheel 144, a remote accelerator pedal 145, a remote brake pedal 146, a remote clutch pedal 147, a remote gear shifter 148, and a driver seat 149, but is not limited thereto.

The body 140a may have any predetermined shape, such as a cockpit and/or a vehicle passenger compartment, but is not limited thereto.

The processing unit 141 (or central processing unit, CPU) may include electronic circuitry to carry out instructions of a computer program by performing basic arithmetic, logical, control and input/output (I/O) operations specified by the instructions. The processing unit 141 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 141 may also include a microprocessor and a microcontroller.

The communication unit 142 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit 143 may include a random access memory (RAM), a read-only memory (ROM), a hard disk, a flash drive, a database connected to the Internet, cloud-based storage, Internet-based storage, or any other type of storage unit.

The remote control assembly 140 may access the Internet via the communication unit 142 to access a website, and/or allow a mobile application and/or the software application to be executed using the processing unit 141. For ease of description, the mobile and/or the software application will be hereinafter referred to as an app. The app may be downloaded from the Internet, such as the storage device 110, to be stored on the storage unit 143. In other words, the program stored on the storage device 110 may be the same as the app stored on the storage unit 143 of the remote control assembly 140 and/or the vehicle driving unit 130.

The processing unit 141 executing the app may send a vehicle control command to the communication unit 142 that is transmitted to the communication unit 132 of the vehicle driving unit 130. Subsequently, the processing unit 131 may receive the vehicle control command from the communication unit 132. The vehicle control command from the processing unit 141 may be based on an operation of the at least one vehicle 10, such as steering, accelerating, changing gears, and/or braking. Moreover, the processing unit 141 executing the app may send the vehicle control command to the vehicle driving unit 130 that performs any of the functions discussed above with respect to the autonomous driving mode.

The remote steering wheel 144 may also include input buttons for vehicle operations, such as temperature control, radio control, headlight functions, windshield wipers, door lock and/or unlock, window control, and/or any other vehicle operations. Alternatively, the remote steering wheel 144 may have at least one button to receive vocal inputs, such that the processing unit 141 executing the app may send the vehicle control command to the vehicle driving unit 130 in response to a vocal command from a user corresponding to any other vehicle operations described herein.

The remote steering wheel 144 may be movably (i.e., rotatably) disposed on at least a portion of the body 140a. The remote steering wheel 144 may rotate in a first rotational direction (i.e., clockwise) or a second rotational direction (i.e., counterclockwise).

The remote accelerator pedal 145 may be movably (i.e. pivotally) disposed on at least a portion of the body 140a via a spring and/or a hydraulic cylinder connected thereto. The remote accelerator pedal 145 may pivot in a first lateral direction or a second lateral direction in response to being depressed, such as stepping and/or pushing with a foot. Conversely, the remote accelerator pedal 145 may pivot in the second lateral direction or the first lateral direction to an original position in response to a lack of an application force thereon due to a spring bias and/or extension of the hydraulic cylinder.

The remote brake pedal 146 may be movably (i.e. pivotally) disposed on at least a portion of the body 140a via a spring and/or a hydraulic cylinder connected thereto. The remote brake pedal 146 may pivot in a first lateral direction or a second lateral direction in response to being depressed, such as stepping and/or pushing with a foot. Conversely, the remote brake pedal 146 may pivot in the second lateral direction or the first lateral direction to an original position in response to a lack of an application force thereon due to a spring bias and/or extension of the hydraulic cylinder.

The remote clutch pedal 147 may be movably (i.e. pivotally) disposed on at least a portion of the body 140a via a spring and/or a hydraulic cylinder connected thereto. The remote clutch pedal 147 may pivot in a first lateral direction or a second lateral direction in response to being depressed, such as stepping and/or pushing with a foot. Conversely, the remote clutch pedal 147 may pivot in the second lateral direction or the first lateral direction to an original position in response to a lack of an application force thereon due to a spring bias and/or extension of the hydraulic cylinder.

The remote gear shifter 148 may be movably (i.e. pivotally) disposed on at least a portion of the body 140a via a hinge. The remote gear shifter 148 may pivot in a first lateral direction or a second lateral direction (e.g., to at least one gear) in response to an application of force thereon. The remote clutch pedal 147 may be depressed to facilitate changing gears using the remote gear shifter 148.

In operation, the processing unit 141 executing the app may link the remote steering wheel 144 to the steering wheel 11 in the at least one vehicle 10, the remote accelerator pedal 145 and/or the remote clutch pedal 147 to the accelerator/clutch pedal 12 in the at least one vehicle 10, and/or the remote brake pedal 146 to the brake pedal 13 in the at least one vehicle 10, and/or the remote gear shifter 148 to the gear shifter 14 of the at least one vehicle 10. In other words, the components within the at least one vehicle 10 may move in response to the corresponding and similar components of the remote control assembly 140.

The steering wheel 11 may rotate corresponding to a rotation of the remote steering wheel 144 in response to the processing unit 141 transmitting the vehicle control command from the communication unit 142 to the communication unit 132, such that the processing unit 131 may command the control motor 135 to at least partially rotate the steering wheel 11. Similarly, the accelerator pedal 12 may be depressed corresponding to the remote accelerator pedal 145 being depressed in response to the processing unit 141 transmitting the vehicle control command from the communication unit 142 to the communication unit 132, such that the processing unit 131 may command the control motor 135 to at least partially depress the accelerator pedal 12. The brake pedal 13 may be depressed corresponding to the remote brake pedal 146 being depressed in response to the processing unit 141 transmitting the vehicle control command from the communication unit 142 to the communication unit 132, such that the processing unit 131 may command the control motor 135 to at least partially depress the brake pedal 13. The clutch pedal 12 may be depressed corresponding to the remote clutch pedal 147 being depressed in response to the processing unit 141 transmitting the vehicle control command from the communication unit 142 to the communication unit 132, such that the processing unit 131 may command the control motor 135 to at least partially depress the clutch pedal 12. Lastly, the gear shifter 14 may slide corresponding to the remote gear shifter 148 being moved in response to the processing unit 141 transmitting the vehicle control command from the communication unit 142 to the communication unit 132, such that the processing unit 131 may command the control motor 135 to at least partially slide the gear shifter 14, such that the at least one vehicle 10 may change gears. Each of the components within the at least one vehicle 10 may move simultaneously in response to movement of the same components of the remote control assembly 140.

As such, the remote control assembly 140 may remotely control operations of the at least one vehicle 10, such that the at least one vehicle 10 may be driven in response to commands from the remote control assembly 140. Accordingly, the vehicle driving unit 130 may operate at least one component of the at least one vehicle 10 in response to activating the at least one component of the remote control assembly 140, such that the at least one component of the remote control assembly 140 may correspond to the at least one component of the at least one vehicle 10.

Therefore, the remote control assembly 140 may override the autonomous driving mode of the vehicle driving unit 130. As a result, the vehicle driving unit 130 may execute at least one command received from the remote control assembly 140 to control the at least one vehicle 10. However, the autonomous driving mode of the vehicle driving unit 130 may be initiated using an autonomous driving button on the remote steering wheel 144.

The seat 149 may be disposed on at least a portion of the body 140a. The seat 149 may receive the user thereon.

The display assembly 150 may include an eyewear body 151 and a display unit 152, but is not limited thereto.

The eyewear body 151 may include goggles, glasses, monocles, lenses, shades, and/or any other type of eyewear, but is not limited thereto.

The eyewear body 151 may be removably connected to at least a portion of a head of the user. In other words, the eyewear body 151 may be worn over eyes of the user. Also, the eyewear body 151 may be removably connected to the remote control assembly 140, such as via an electronically wired connection and/or a wireless connection, such as Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The display unit 152 may include a plasma screen, an LCD screen, a light emitting diode (LED) screen, an organic LED (OLED) screen, a computer monitor, a hologram output unit, a sound outputting unit, or any other type of device that visually or aurally displays data.

The display unit 152 may be disposed on at least a portion of the eyewear body 151, such that at least one eye of the user may view the display unit 152 while the eyewear body 151 is disposed on the user. Moreover, the processing unit 141 may retrieve the app from the storage unit 143 to execute the app, such that the display unit 152 may provide a visual experience to the user.

The visual experience may include any image, picture, movie, and/or graphic based on code within the app. The visual experience may be an enhanced visualization of the surrounding environment and/or the interior environment of the at least one vehicle 10. The display unit 152 may receive the camera data from the plurality of exterior cameras 121 and/or the plurality of interior cameras 122. Moreover, referring to FIG. 2B, the display unit 152 may dynamically (i.e., in real-time) generate a virtual reality (VR) image on the display unit 152, such the display unit 152 may overlay (i.e. superimpose) the camera data (e.g., a view of the interior of the at least one vehicle 10) with vehicle information, such as at least one surrounding vehicle 20, autonomous driving mode 30, a speedometer 40, and/or any other information related to operation of the at least one vehicle 10. In other words, the display unit 152 may constantly adjust the VR image on the display unit 152 based on the camera data. It is important to note that the display unit 152 may generate and/or render the VR image, such that the VR image may be a replica and not simply the camera data received from the plurality of cameras 120.

Furthermore, the processing unit 141 may identify and/or detect the at least one surrounding vehicle 20, an object, and/or a pedestrian, such that the display unit 152 may heighten alertness to the user by changing the at least one surrounding vehicle 20, the object, and/or the pedestrian to a color (e.g., red) that highlights the at least one surrounding vehicle 20, the object, and/or the pedestrian on the display unit 152. Alternatively, referring to FIG. 2B, the display unit 152 may surround the at least one surrounding vehicle 20 with a border, such as a square. Also, the display unit 152 may display a warning (e.g., a word, a phrase, an auditory alert) thereon to alert the user to potential problems surrounding the at least one vehicle 10, such as potential collisions, pedestrians, traffic jams along a current route of travel, weather, slippery roads, and/or any other problems.

Referring to FIG. 1, the network 160 may be at least one of the Internet, a cellular network, a universal mobile telecommunications systems (UMTS) network, a Long Term Evolution (LTE) network, a Global System for Mobile Communications (GSM) network, a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. The network 160 can be implemented with any number of hardware and software components, transmission media, and network protocols. FIG. 1 illustrates the network 160 as a single network, but is not limited thereto.

The vehicle driving unit 130 and/or the remote control assembly 140 may send data to and/or receive data from the storage device 110 over via the Internet or any of the above-mentioned networks. The vehicle driving unit 130 and/or the remote control assembly 140 can be directly coupled to the storage device 110. Alternatively, the vehicle driving unit 130 and/or the remote control assembly 140 may be connected to the storage device 110 via any other suitable device, communication network, and/or combination thereof. For example, the vehicle driving unit 130 and/or the remote control assembly 140 may be coupled to the storage device 110 via routers, switches, access points, and/or communication networks. In other words, the storage device 110, the vehicle driving unit 130, and/or the remote control assembly 140 may all communicate with each other via the network 160.

Furthermore, any new data input and/or stored on the storage device 110, the storage unit 133 of the vehicle driving unit 130, and/or the storage unit 143 of the remote control assembly 140 may be periodically transmitted to each other component, such that the each other component may be updated. In other words, the storage device 110, the storage unit 133 of the vehicle driving unit 130, and/or the storage unit 143 of the remote control assembly 140 may synchronize to keep the app and any data updated.

During use, the remote control assembly 140 may facilitate remote control of the at least one vehicle 10 using the vehicle driving unit 130. Moreover, the remote control assembly 140 may control the at least one vehicle 10 without the user actually being present within the at least one vehicle 10. The remote control assembly 140 may be used to drive the at least one vehicle 10 through inner city environments until reaching a highway and/or an expressway. The vehicle driving unit 130 may be set to use the autonomous driving mode on the highway and/or the expressway. Upon reaching another inner city environment, the vehicle driving unit 130 may park the at least one vehicle 10 to await further control by the user. Also, the vehicle driving unit 130 may notify the user on the remote control assembly 140 and/or the display assembly 150 using visual and/or auditory alerts.

Therefore, the vehicle remote control system 100 may allow the at least one person to remotely control and/or drive the at least one vehicle 10. Additionally, the vehicle remote control system 100 may reduce costs by not requiring the user to remain present in the at least one vehicle 10 during a long drive.

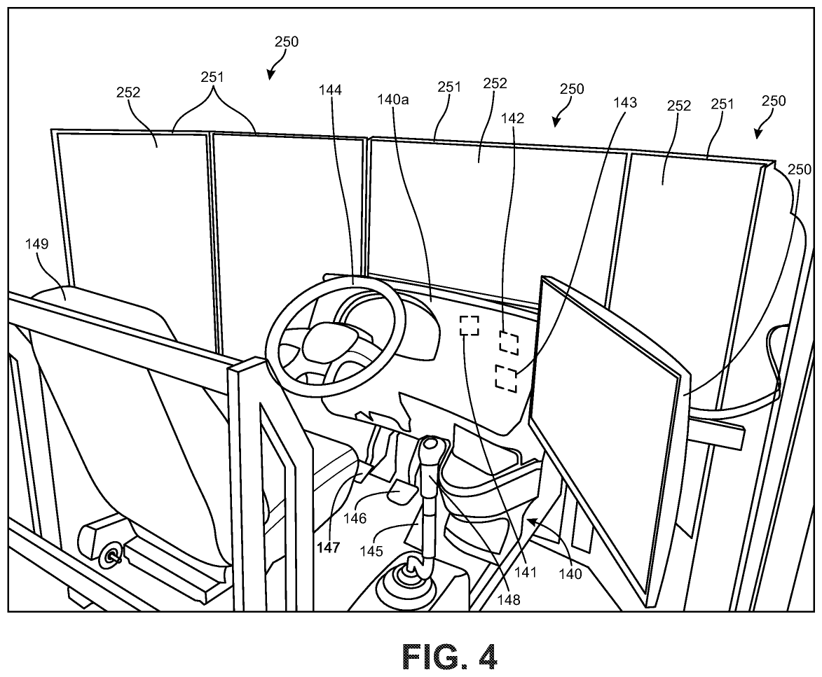

FIG. 4 illustrates a perspective view of the remote control assembly 140 and a display assembly 250, according to another exemplary embodiment of the present general inventive concept.

It is important to note that the display assembly 250 may connect to and interact with all components described above and is used instead of and/or in addition to the display assembly 150.

The display assembly 250 may include a monitor body 251 and a display unit 252, but is not limited thereto. Also, referring to FIG. 4, the display assembly 250 may be a plurality of monitors 250. In other words, each of the plurality of monitors 250 may include the monitor body 251 and the display unit 252, but is not limited thereto.

The monitor body 251 may include a monitor, a television, a light-emitting diode display, a quantum dot display, a digital light processing display, a plasma display, and a liquid crystal display, but is not limited thereto.

The monitor body 251 may be removably connected to at least a portion of the remote control assembly 140, such as via an electronically wired connection and/or a wireless connection, such as Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The display unit 252 may include a plasma screen, an LCD screen, a light emitting diode (LED) screen, an organic LED (OLED) screen, a computer monitor, a hologram output unit, a sound outputting unit, or any other type of device that visually or aurally displays data.

The display unit 252 may be disposed on at least a portion of the monitor body 251. Moreover, the processing unit 141 may retrieve the app from the storage unit 143 to execute the app, such that the display unit 252 may provide a visual experience to the user.

The visual experience may include any image, picture, movie, and/or graphic based on code within the app. The visual experience may be an enhanced visualization of the surrounding environment and/or the interior environment of the at least one vehicle 10. The display unit 252 may receive the camera data from the plurality of exterior cameras 121 and/or the plurality of interior cameras 122. Moreover, referring again to FIG. 2B, the display unit 252 may dynamically (i.e., in real-time) generate a rendered image on the display unit 152, such the display unit 152 may overlay (i.e. superimpose) on the camera data (e.g., a view of the interior of the at least one vehicle 10) with vehicle information, such as at least one surrounding vehicle 20, autonomous driving mode 30, a speedometer 40, and/or any other information related to operation of the at least one vehicle 10. In other words, the display unit 252 may constantly adjust the rendered image on the display unit 252 based on the camera data. It is important to note that the display unit 252 may generate and/or render the rendered image, such that the rendered image may be a replica and not simply the camera data received from the plurality of cameras 120.

Furthermore, the processing unit 141 may identify and/or detect the at least one surrounding vehicle 20, an object, and/or a pedestrian, such that the display unit 252 may heighten alertness to the user by changing the at least one surrounding vehicle 20, the object, and/or the pedestrian to a color (e.g., red) that highlights the at least one surrounding vehicle 20, the object, and/or the pedestrian on the display unit 252. Alternatively, referring again to FIG. 2B, the display unit 252 may surround the at least one surrounding vehicle 20 with a border, such as a square. Also, the display unit 252 may display a warning (e.g., a word, a phrase, an auditory alert) thereon to alert the user to potential problems surrounding the at least one vehicle 10, such as potential collisions, pedestrians, traffic jams along a current route of travel, weather, slippery roads, and/or any other problems.

The present general inventive concept may include a vehicle remote control system 100 having a program running thereon, the vehicle remote control system 100 including a storage device 110 to store data regarding at least one vehicle 10, a remote control assembly 140 connected to the storage device 110 and the at least one vehicle 10 to control the at least one vehicle 10 corresponding to at least one component of the remote control assembly 140, and a display assembly 150 to be worn by a user and connected to the remote control assembly 140 to display a virtual reality image based on an exterior environment and an interior environment of the at least one vehicle 10 thereon.

The remote control assembly 140 may include a body 140a, a processing unit 141 disposed within at least a portion of the body 140a to determine a vehicle control command based on the program, a remote steering wheel 144 rotatably disposed on at least a portion of the body 140a to at least partially rotate a steering wheel 11 of the at least one vehicle 10 in response to rotation of the remote steering wheel 144, a remote accelerator pedal 145 movably disposed on at least a portion of the body 140a to at least partially depress an accelerator pedal 12 of the at least one vehicle 10 in response to depressing the remote accelerator pedal 145, a remote brake pedal 146 movably disposed on at least a portion of the body 140a to at least partially depress a brake pedal 13 of the at least one vehicle 10 in response to depressing the remote brake pedal 146, and a remote gear shifter 148 movably disposed on at least a portion of the body 140a to move a gear shifter 14 of the at least one vehicle 10 in response to moving the remote gear shifter 148.

The remote control assembly 140 may further include a remote clutch pedal 147 movably disposed on at least a portion of the body 140a to at least partially depress a clutch pedal 12 of the at least one vehicle 10 in response to depressing the remote clutch pedal 147.

The display assembly 150 may include an eyewear body 151, and a display unit 152 disposed on at least a portion of the eyewear body 151 to generate the virtual reality image on the display unit 152 based on the exterior environment and the interior environment of the at least one vehicle 10.

The display unit 152 may dynamically generate the virtual reality image.

The display unit 152 may generate an overlay of information related to operation of the at least one vehicle 10 over the virtual reality image.

The display assembly 150 may change at least one of at least one surrounding vehicle 20, an object, and a pedestrian to a color in response to identifying a presence of at least one of the at least one surrounding vehicle 20, the object, and the pedestrian.

The display assembly 150 may display a warning to identify potential problems surrounding the at least one vehicle 10, such that the potential problems are at least one of potential collisions, pedestrians, traffic jams along a current route of travel, weather, and slippery roads.

The vehicle remote control system 100 may further include a plurality of cameras 120 disposed on at least a portion of the at least one vehicle to record at least one of an image and a video of the exterior environment and the interior environment of the at least one vehicle 10.

The vehicle remote control system 100 may further include a vehicle driving unit 130 disposed on at least a portion of the at least one vehicle 10 to operate at least one component of the at least one vehicle 10 in response to activating the at least one component of the remote control assembly 140, such that the at least one component of the remote control assembly 140 corresponds to the at least one component of the at least one vehicle 10.

The present general inventive concept may also include a vehicle remote control system 1100 having a program running thereon, the vehicle remote control system 100 including a storage device 110 to store data regarding at least one vehicle 10, a remote control assembly 140 connected to the storage device 110 and the at least one vehicle 10 to control the at least one vehicle 10 corresponding to at least one component of the remote control assembly 140, and a plurality of monitors 250 removably connected to at least a portion of the remote control assembly 140 to display an exterior environment and an interior environment of the at least one vehicle 10 thereon.

The remote control assembly 140 may include a body 140a, a processing unit 141 disposed within at least a portion of the body 140a to determine a vehicle control command based on the program, a remote steering wheel 144 rotatably disposed on at least a portion of the body 140a to at least partially rotate a steering wheel 11 of the at least one vehicle 10 in response to rotation of the remote steering wheel 144, a remote accelerator pedal 145 movably disposed on at least a portion of the body 140a to at least partially depress an accelerator pedal 12 of the at least one vehicle 10 in response to depressing the remote accelerator pedal 145, a remote brake pedal 146 movably disposed on at least a portion of the body 140a to at least partially depress a brake pedal 13 of the at least one vehicle 10 in response to depressing the remote brake pedal 146, and a remote gear shifter 148 movably disposed on at least a portion of the body 140a to move a gear shifter 14 of the at least one vehicle 10 in response to moving the remote gear shifter 148.

The remote control assembly 140 may further include a remote clutch pedal 147 movably disposed on at least a portion of the body 140a to at least partially depress a clutch pedal 12 of the at least one vehicle 10 in response to depressing the remote clutch pedal 147.

Each of the plurality of monitors 250 may include a monitor body 251, and a display unit 252 disposed on at least a portion of the monitor body 251 to generate a rendered image on the display unit 252 based on the exterior environment and the interior environment of the at least one vehicle 10.

The display unit 252 may dynamically generate the rendered image.

The display unit 252 may generate an overlay of information related to operation of the at least one vehicle 10 over the rendered image.

Each of the plurality of monitors 250 may change at least one of at least one surrounding vehicle 20, an object, and a pedestrian to a color in response to identifying a presence of at least one of the at least one surrounding vehicle 20, the object, and the pedestrian.

Each of the plurality of monitors 250 may display a warning to identify potential problems surrounding the at least one vehicle 10, such that the potential problems may be at least one of potential collisions, pedestrians, traffic jams along a current route of travel, weather, and slippery roads.

The vehicle remote control system 100 may further include a plurality of cameras 120 disposed on at least a portion of the at least one vehicle 10 to record at least one of an image and a video of the exterior environment and the interior environment of the at least one vehicle 10.

The vehicle remote control system 100 may further include a vehicle driving unit 130 disposed on at least a portion of the at least one vehicle 10 to operate at least one component of the at least one vehicle 10 in response to activating the at least one component of the remote control assembly, 140 such that the at least one component of the remote control assembly 140 corresponds to the at least one component of the at least one vehicle 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A vehicle remote control system having a program running thereon, the vehicle remote control system comprising:
a storage device to store data regarding at least one vehicle;
a remote control assembly connected to the storage device and the at least one vehicle to control the at least one vehicle corresponding to at least one component of the remote control assembly; and
a display assembly to be worn by a user and connected to the remote control assembly to display a virtual reality image based on an exterior environment and an interior environment of the at least one vehicle thereon.

2. The vehicle remote control system of claim 1, wherein the remote control assembly comprises:
a body;
a processing unit disposed within at least a portion of the body to determine a vehicle control command based on the program;
a remote steering wheel rotatably disposed on at least a portion of the body to at least partially rotate a steering wheel of the at least one vehicle in response to rotation of the remote steering wheel;
a remote accelerator pedal movably disposed on at least a portion of the body to at least partially depress an accelerator pedal of the at least one vehicle in response to depressing the remote accelerator pedal;
a remote brake pedal movably disposed on at least a portion of the body to at least partially depress a brake pedal of the at least one vehicle in response to depressing the remote brake pedal; and
a remote gear shifter movably disposed on at least a portion of the body to move a gear shifter of the at least one vehicle in response to moving the remote gear shifter.

3. The vehicle remote control system of claim 2, wherein the remote control assembly further comprises:
a remote clutch pedal movably disposed on at least a portion of the body to at least partially depress a clutch pedal of the at least one vehicle in response to depressing the remote clutch pedal.

4. The vehicle remote control system of claim 1, wherein the display assembly comprises:
an eyewear body; and
a display unit disposed on at least a portion of the eyewear body to generate the virtual reality image on the display unit based on the exterior environment and the interior environment of the at least one vehicle.

5. The vehicle remote control system of claim 4, wherein the display unit dynamically generates the virtual reality image.

6. The vehicle remote control system of claim 4, wherein the display unit generates an overlay of information related to operation of the at least one vehicle over the virtual reality image.

7. The vehicle remote control system of claim 1, wherein the display assembly changes at least one of at least one surrounding vehicle, an object, and a pedestrian to a color in response to identifying a presence of at least one of the at least one surrounding vehicle, the object, and the pedestrian.

8. The vehicle remote control system of claim 1, wherein the display assembly displays a warning to identify potential problems surrounding the at least one vehicle, such that the potential problems are at least one of potential collisions, pedestrians, traffic jams along a current route of travel, weather, and slippery roads.

9. The vehicle remote control system of claim 1, further comprising:
a plurality of cameras disposed on at least a portion of the at least one vehicle to record at least one of an image and a video of the exterior environment and the interior environment of the at least one vehicle.

10. The vehicle remote control system of claim 1, further comprising:
a vehicle driving unit disposed on at least a portion of the at least one vehicle to operate at least one component of the at least one vehicle in response to activating the at least one component of the remote control assembly, such that the at least one component of the remote control assembly corresponds to the at least one component of the at least one vehicle.

11. A vehicle remote control system having a program running thereon, the vehicle remote control system comprising:
a storage device to store data regarding at least one vehicle;
a remote control assembly connected to the storage device and the at least one vehicle to control the at least one vehicle corresponding to at least one component of the remote control assembly; and
a plurality of monitors removably connected to at least a portion of the remote control assembly to display an exterior environment and an interior environment of the at least one vehicle thereon.

12. The vehicle remote control system of claim 11, wherein the remote control assembly comprises:
a body;
a processing unit disposed within at least a portion of the body to determine a vehicle control command based on the program;
a remote steering wheel rotatably disposed on at least a portion of the body to at least partially rotate a steering wheel of the at least one vehicle in response to rotation of the remote steering wheel;
a remote accelerator pedal movably disposed on at least a portion of the body to at least partially depress an accelerator pedal of the at least one vehicle in response to depressing the remote accelerator pedal;
a remote brake pedal movably disposed on at least a portion of the body to at least partially depress a brake pedal of the at least one vehicle in response to depressing the remote brake pedal; and
a remote gear shifter movably disposed on at least a portion of the body to move a gear shifter of the at least one vehicle in response to moving the remote gear shifter.

13. The vehicle remote control system of claim 12, wherein the remote control assembly further comprises:
a remote clutch pedal movably disposed on at least a portion of the body to at least partially depress a clutch pedal of the at least one vehicle in response to depressing the remote clutch pedal.

14. The vehicle remote control system of claim 11, wherein each of the plurality of monitors comprises:
a monitor body; and
a display unit disposed on at least a portion of the monitor body to generate a rendered image on the display unit based on the exterior environment and the interior environment of the at least one vehicle.

15. The vehicle remote control system of claim 14, wherein the display unit dynamically generates the rendered image.

16. The vehicle remote control system of claim 14, wherein the display unit generates an overlay of information related to operation of the at least one vehicle over the rendered image.

17. The vehicle remote control system of claim 11, wherein each of the plurality of monitors changes at least one of at least one surrounding vehicle, an object, and a pedestrian to a color in response to identifying a presence of at least one of the at least one surrounding vehicle, the object, and the pedestrian.

18. The vehicle remote control system of claim 11, wherein the each of the plurality of monitors displays a warning to identify potential problems surrounding the at least one vehicle, such that the potential problems are at least one of potential collisions, pedestrians, traffic jams along a current route of travel, weather, and slippery roads.

19. The vehicle remote control system of claim 11, further comprising:
a plurality of cameras disposed on at least a portion of the at least one vehicle to record at least one of an image and a video of the exterior environment and the interior environment of the at least one vehicle.

20. The vehicle remote control system of claim 11, further comprising:
a vehicle driving unit disposed on at least a portion of the at least one vehicle to operate at least one component of the at least one vehicle in response to activating the at least one component of the remote control assembly, such that the at least one component of the remote control assembly corresponds to the at least one component of the at least one vehicle.
